(19) United States
(12) Patent Application Publication
(10) Pub. No.: US 2020/0258674 A1
(43) Pub. Date: Aug. 13, 2020

(54) WIRE-BASED INDUCTORS

(71) Applicant: Raytheon Company, Waltham, MA (US)

(72) Inventors: Jonathan Frasch, McKinney, TX (US); Gary A. Frazier, Garland, TX (US); Kyle L. Grosse, Dallas, TX (US)

(21) Appl. No.: 16/273,225

(22) Filed: Feb. 12, 2019

(51) Int. Cl. H01F 27/28; H01F 27/24; H01F 1/42; H01F 41/069; H01F 27/34; D02G 3/36; D02G 3/02; D02G 3/44

(52) U.S. Cl. CPC H01F 27/2823; H01F 27/24; H01F 1/42; H01F 41/069; H01F 27/34; D10B 2101/122; D02G 3/02; D02G 3/441; D02G 3/447; H01F 2027/2838; D10B 2401/16; D02G 3/36

(57) ABSTRACT

A continuous wire that includes a wound inductance from a first yarn material formed of filaments or nanotubes, the first yarn being doped with or including a first material that causes it to be electrically conductive and a second yarn formed of material filaments or nanotubes that is electrically insulating and may include magnetic particles wound with the first yarn in bifilar fashion or both yarns wrapped in a bifilar fashion around an insulating core yarn which may include magnetic particles to increase the inductance of the wire. The doping and electrical conductance of the yarns can be varied along the length of the wire to integrate sections of lumped electrical conductance and inductance.

### BACKGROUND

The present invention relates to wires and, more specifically, to a continuous wire formed such that it includes a wound inductor integrally formed therein.

A large number of radar systems require a radome or other window to provide environmental protection to electronic devices while still allowing for radio frequency (RF) signals to pass through the radome/window (generally referred to as “surfaces” or “optically transparent surfaces” herein), especially in airborne situations. Such surfaces are sometimes designed and optimized to have high performance characteristics in that they provide for minimum radio frequency (RF) insertion loss, are ruggedized for environmental protection and are relatively light weight. The surfaces can be designed for commercial and/or military applications and can be optimized for different frequency bands of the electromagnetic spectrum.

In some windows, low-resistance wires are utilized as resistive heaters to regulate a temperature of the surfaces to prevent frost formation or condensation on the surfaces. Using such wires may require lower bias voltages to dissipate electrical power than higher-resistance wires. However, low-resistance wires are unusable in RF passing surfaces as the low-resistance wires may create an electromagnetic shield that blocks the transmission of desired electromagnetic energy. In some cases it is also desirable to pass optical radiation through the radome or window. In some prior art instances, standard inductors are connected to the heating wires affixed to optical windows to provide a tuned circuit that allows one or more RF frequencies of interest to pass through the surfaces while allowing optical energy (light) to pass through the window. These inductors can be included on or embedded into the surface of the window and, being optically opaque, may obscure the window and block the transmission of visible or infrared radiation through the window.

### SUMMARY

According to one embodiment of the present invention, a continuous wire that includes a formed lumped-element inductor is disclosed. The wire includes a first yarn, formed of material filaments or nanotubes, the first yarn being doped with or composed of a first material that causes it to become electrically conductive, a second yarn, formed of material filaments or nanotubes, that is undoped or electrically insulating wound with the first yarn in bifilar fashion.

According to a wire of any prior embodiment, the first material includes materials that change physical properties based on exposure to changes in environment including temperature, vibration, or exposure to radiation and alterations to the chemistry of materials in the vicinity (e.g., ph levels).

According to a wire of any prior embodiment, the second wire is selectively doped with a second material in local regions that causes it to become conductive in the local regions.

According to a wire of any prior embodiment, the second material is the same as the first material.

According to a wire of any prior embodiment, the first material, the second material, or both, include materials that change physical properties based on their environment including temperature, vibration, or exposure to radiation and alterations to the chemistry of materials in the vicinity (e.g., ph levels).

According to a wire of any prior embodiment, a thickness of the second yarn is greater than a thickness of the first yarn.

According to a wire of any prior embodiment, the wire further includes a core yarn around which the first and second yarns are wound.

According to a wire of any prior embodiment, the core yarn is doped with magnetic elements.

According to a wire of any prior embodiment, a thickness of the core is greater than the thickness of the first yarn.

According to a wire of any prior embodiment, one of the first and second yarns is formed of carbon nanotubes.

Also disclosed is a frequency selective surface having a wire as in any prior embodiment or otherwise disclosed herein embedded therein.

Also disclosed microelectronic device having a wire as in any prior embodiment or otherwise disclosed herein embedded therein.

In one embodiment, a method of forming a continuous wire that includes an inductance is disclosed. The method includes: forming a first yarn of material filaments or nanotubes; doping first yarn with a first material that causes it to become conductive; forming a second yarn of material filaments or nanotubes; and winding the first and second yarns together in bifilar fashion to form bifilar wound first and second yarns.

According to a method of any prior embodiment, one of the first and second yarns is formed of carbon nanotubes.

According to a method of any prior embodiment, the second wire is selectively doped with a second material in local regions that causes it to become conductive in the local regions.

According to a method of any prior embodiment, the second material is the same as the first material.

According to a method of any prior embodiment, the first material, the second material, or both, include materials that change physical properties based on exposure to changes in the environment including temperature, vibration, or exposure to radiation and alterations to the chemistry of materials in the vicinity (e.g., ph levels).

According to a method of any prior embodiment, the thickness of the second yarn is greater than a thickness of the first yarn.

According to a method of any prior embodiment, the method further includes: forming a core yarn; and winding the bifilar wound first and second yarns around the core yarn.

According to a method of any prior embodiment, forming the core yarn includes doping the core yarn with magnetic materials.

According to a method of any prior embodiment, one of the first and second yarns is formed of an electrically non-conducting polymer.

In any of the prior embodiments, a continuous metal wire could be fashioned into the inductor and non-conducting carbon nanotubes, insulating boron-nitride nanotubes, or non-conductive polymers could be used as the spacer between the turns of the inductor sections.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 shows a continuous wire formation system and a wire formed by it;

FIG. 2 also shows a continuous wire formation system and a wire formed by it;

FIG. 3 shows a continuous wire formation system and a wire formed by it that includes discreet inductors therein;

FIG. 4 shows two different yarns according to one embodiment; and

FIG. 5 shows a continuous wire that is formed by winding a bifilar wound pair of yarns around a core.

### DETAILED DESCRIPTION

As will be described below, a method of forming a continuous wire that includes one or more inductors formed thereon is disclosed herein. The methods disclosed herein can produce wires with appreciable, controlled inductance at small length scales. Indeed, the skilled artisan will appreciate that one or more embodiments disclosed herein can be used to form wires with independently controllable resistance and inductance either in discrete locations or spread over a substantial length of the wire.

In addition, the methods can introduce physically large inductances into optically transparent surfaces (e.g., into a surface such as a window or radome) without increasing obscuration of the surface.

The wires can be formed by winding an electrically conductive micro- or nano-scale yarn around an insulating yarn There a different ways that this can be done disclosed herein.

The conducting yarn can be a carbon nanotube yarn in one embodiment that is doped so that it is electrically conductive. The electrically insulating yarn can also be a nanotube yarn (or several such yarns wound together) and it can be an un-doped in one embodiment. In one embodiment, the electrically conducting yarn and the insulating yarn are wound together in bifilar manner where one yarn serves to provide a spacer between the turns of the inductor to prevent electrical shorts between the windings of the inductor. Further, the insulating yarn can be formed of one or more insulating yarns (e.g., un-doped nanotubes yarns) wound together as a bundle.

In one embodiment, both the insulating yarn and the electrically conductive yarn are conductive over at least a portion of their length. In a region where an inductor is desired, one of the insulating yarn is un-doped and, thus, not electrically conductive in that region. In this manner, the un-doped yarn forms the “inductor core” around which the electrically conductive yarn (doped carbon nanotube) is wrapped to form the inductor. The un-doped yarn in this structure serves as an approximately cylindrical scaffold to support the inductor formed thereupon. In an alternative embodiment, insulating portions can be spliced into one of the nanotubes to provide the “core.”

In either of the above embodiments, the electrically conductive and insulating yarn can be wrapped around a central non-conductive core. The wires formed in the above manners can be used to form Frequency Selective Surface (FSS) Layers or for Micro-electronic devices or other devices.

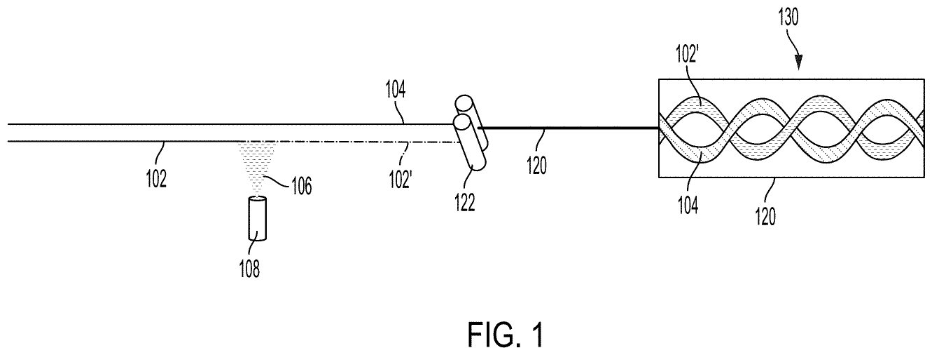

FIG. 1 shows first and second yarns 102, 104 that are wound together to form a continuous yarn 120 (or wire) that is electrically conductive and has a desired inductance.

The yarns 102, 104 can be formed nano- or micro-sized fibers in one embodiment. The term “yarn” is defined as a bundle of filaments (e.g., carbon nanotubes) approximately spirally arranged to form an approximately cylindrical structure.

In one embodiment, the yarns 102, 104 can be formed, for example, by continuously pulling and twisting nano-filaments from a filament forest with a spinning machine to create a yarn similar to transitional textile yarns. Thus, each yarn 102, 104 is actually a combination of millions of nano-filaments. In the embodiment of FIG. 1 it shall be assumed that the yarns so produced are non-conductive in the following discussion. However, the skilled artisan will realize that either? the yarns 102, 104 could be electrically conductive and just the coatings described below changed.

These two yarns 102, 104 are wound together in bifilar manner by a winding machine 122 to produce the continuous wire 120.

The first yarn 102 can be coated with an electrically conductive material 106 delivered onto it by a coating mechanism 108 so that it becomes an electrically conductive first yarn 102′. The coating mechanism 108 can cause a change in the yarn by implanting materials into the yarn to make it electrically conductive or by coating the yarn with an electrically conductive material. The electrically conductive material 106 can be, for example, thin film coatings of metals or dispersion of metallic or ferromagnetic particles.

In the embodiment of FIG. 1, the second yarn 104 can be formed such that is thicker than the first yarn 102. This may be accomplished by spinning several second yarns together and then winding them with conductive materially coated first yarn 102′. The thicker second yarn 104 will increase the effective coil radius of the inductor formed in the wire 120. Furthermore the second yarn can include ferromagnetic materials such as iron to enhance its effectiveness as an inductive core.

Regardless of how formed, as shown in FIG. 1, a magnified portion 130 of the continuous wire 120 is shown. The inductance of the wire 110 of this embodiment is distributed over the length of the wire. The number of turns and winding ratio will determine the inductance.

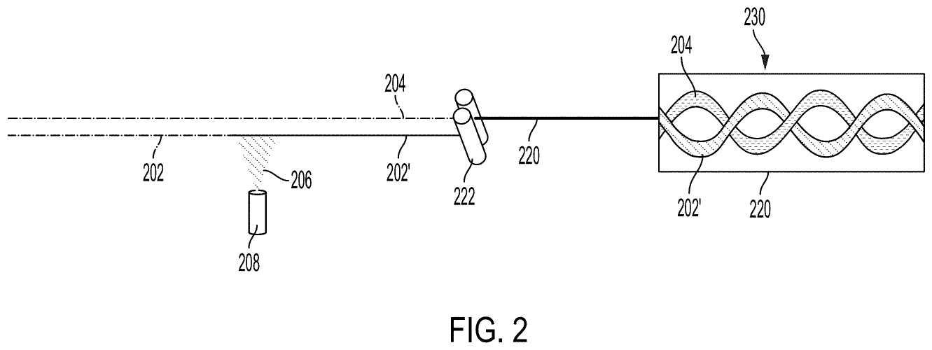

FIG. 2 shows another embodiment. In this embodiment, yarns 202, 204 are again nano- or micro-sized fibers in one embodiment. The yarns 202, 104 can be formed, for example, as described above. In the embodiment of FIG. 2 it shall be assumed that the yarns so produced are electrically conductive in the following discussion.

These two yarns 202, 204 are wound together in bifilar manner by a winding machine 220 to produce the continuous wire 220.

The first yarn 202 can be coated with an electrically non-conductive material 206 delivered onto it by a coating mechanism 208 so that it becomes a non-conductive first yarn 202′. The non-conductive material 206 can be, for example, a thin film coating of an insulating film such as a ceramic or non-conductive polymer.

In the embodiment of FIG. 2, the first yarn 202 can be formed such that is thicker than the second yarn 204. This may be accomplished by spinning several yarns together and then winding them with conductive second yarn 204.

Regardless of how formed, as shown in FIG. 2, a magnified portion 230 of the continuous wire 220 is shown. The inductance of the wire 220 of this embodiment is distributed over the length of the wire. The number of turns and winding ratio will determine the inductance.

In either of the above embodiments and the embodiments below, the electrically conductive or non-conductive materials 106, 206 can also include materials that change physical properties through the use of outside stimuli such as temperature, vibration, exposure to radiation and alterations to the chemistry of materials in the vicinity (e.g., ph levels). The materials can be implanted into the yarn (doping) or be in the coating of the yarn and the change in electrical/inductive response of the yarn can be used to sense and measure the changes in environment surrounding the yarn

In the above examples it has been shown how a wire with a desired inductance can be formed where the inductance is distributed over the length of the wire. In another embodiment, discrete inductors can be formed at predetermined locations. Based on yarn thickness, the number of turns in the wire can be controlled to set precise inductances at the locations.

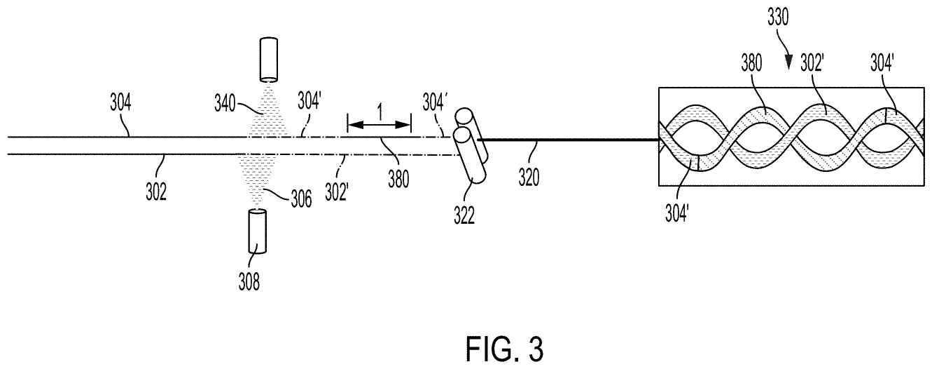

FIG. 3 shows an example of the process of forming such a wire with discrete inductances. In particular, FIG. 3 shows first and second yarns 302, 304 that are wound together to form a continuous yarn 320 (or wire) that is electrically conductive and has a desired inductance at discrete locations. In general, both yarns 302 and 304 are electrically non-conductive. The first yarn 302 is coated with an electrically conductive material 306 deposited by a doping mechanism 308 to make it an electrically conductive yarn 302′.

Like the first yarn 302, the second yarn 304 is also doped/coated with an electrically conductive material 340. The conductive material 340 applied to the second yarn 304 can be the same material as the material 306 that coats/dopes the first yarn 302.

However, unlike the case above related to the first yarn 302, the electrically conductive material 340 is only applied over a portion of the second yarn 304 to form a conductive region 304′ in the second yarn 304. The non-doped/coated portions are denominated by reference numeral 380 in FIG. 3.

These two yarns 302, 304 are wound together in bifilar manner by a winding machine 322 to produce the continuous wire 310.

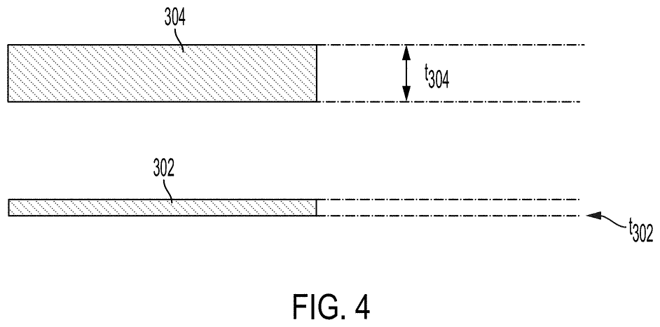

As above, the second yarn 104 can be formed such that is thicker than the first yarn 302. The thicker second yarn 304 relative to the first yarn 302 is shown in FIG. 4. This teaching can be applied in any embodiment herein. That is, FIG. 4 can apply to yarns 102, 104, 202, 204 described above. The greater thickness (t₃₀₄) of the second yard 304 can be selected to define the radius of the core of the inductor formed by winding the first yarn 302 having thickness t₃₀₂ around (or together with) the second yarn 304.

Regardless of how formed, as shown in FIG. 3, a magnified region 330 of the continuous wire 310 is shown. The inductance of the wire 310 in the magnified region 330 is determined at least by the number of turns and winding ratio will determine the inductance. In particular, in the region 330 the length (l) of the non-doped portion 380 will determine the number of turns (along with the relative thicknesses of the first and second yarns 302, 304. The length l can be referred to herein as a local region.

The contrast in electrically conductivity of the insulating yarn (region 380) to the conducting yarn 302′will control the level of leakage in the inductive region 330. If the insulating effect is strong enough, then the inductance of the cable will increase.

In general, the effectiveness of the inductance is dependent on the coil radius, which gets larger as the size of the insulating yarn is increased by braiding/winding more yarns together or making them thicker as describe above.

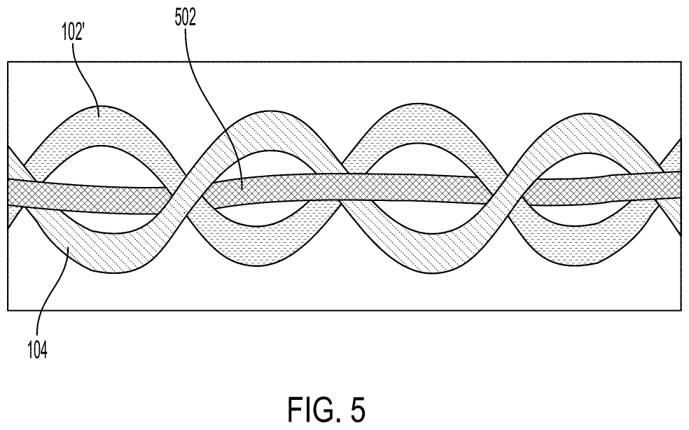

In any of the prior examples above, the first and second yarns can be wrapped around an insulating core that is formed of nano or microfibers. As shown in FIG. 5, the first and second yarns 102′, 104 of FIG. 1 are wrapped around a central core 502. As with the second fibers described above, the central core 502 may be braided to a larger diameter and selectively doped to remove conductivity in specific length sections as in FIG. 3 in alternative embodiments. Further, the core 502 can be doped with magnetic elements to change the inductance as the skilled artisan will realize.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A continuous wire that includes an inductance, the wire including:
a first yarn, formed of material filaments or nanotubes, the first yarn being doped with a first material that causes it to become electrically conductive; and
a second yarn, formed of material filaments or nanotubes, that is undoped or electrically insulating wound with the first yarn in bifilar fashion.

2. The wire of claim 1, wherein a thickness of the second yarn is greater than a thickness of the first yarn.

3. The wire of claim 1, wherein the first material includes materials that change physical properties based on exposure to changes in an environment such as temperature, vibration, or exposure to radiation and alterations to the chemistry of materials in the vicinity).

4. The wire of claim 1, wherein the second wire is selectively doped with a second material in local regions that causes it to become electrically conductive in the local regions.

5. The wire of claim 4, wherein the second material is the same as the first material.

6. The wire of claim 4, wherein the first material, the second material, or both, include materials that change physical properties based on exposure to changes in an environment such as temperature, vibration, or exposure to radiation and alterations to the chemistry of materials in the vicinity).

7. The wire of claim 4, wherein a thickness of the second yarn is greater than a thickness of the first yarn.

8. The wire of claim 1, further comprising:
a core yarn around which the first and second yarns are wound.

9. The wire of claim 8, wherein the core yarn is doped with magnetic elements.

10. The wire of claim 8, where a thickness of the core is greater than the thickness of the first yarn.

11. The wire of claim 1, wherein one of the first and second yarns is formed of carbon nanotubes.

12. A frequency selective surface having wire as claimed in claim 1 embedded therein.

13. A microelectronic device having a wire as claimed in claim 1 therein.

14. A method of forming a continuous wire that includes an inductance, the method comprising:
forming a first yarn of material filaments or nanotubes;
doping first yarn with a first material that causes it to become electrically conductive;
forming a second yarn of material filaments or nanotubes; and
winding the first and second yarns together in bifilar fashion to form bifilar wound first and second yarns.

15. The method of 14, wherein one of the first and second yarns is formed of carbon nanotubes.

16. The method of claim 14, wherein a thickness of the second yarn is greater than a thickness of the first yarn.

17. The method of claim 14, wherein the second wire is selectively doped with a second material in local regions that causes it to become conductive in the local regions.

18. The method of claim 17, wherein the second material is the same as the first material.

19. The method of claim 18, wherein the first material, the second material, or both, include materials that change physical properties based on exposure to changes in an environment such as temperature, vibration, or exposure to radiation and alterations to the chemistry of materials in the vicinity.

20. The method of claim 19, wherein a thickness of the second yarn is greater than a thickness of the first yarn.

21. The method of claim 14, further comprising:
forming a core yarn; and
winding the bifilar wound first and second yarns around the core yam.

22. The method of claim 21, wherein forming the core yarn includes doping the core yarn with magnetic materials.
